(19) United States
(12) Patent Application Publication
(10) Pub. No.: US 2008/0112993 A1
(43) Pub. Date: May 15, 2008

(54) High-dose, long-lasting ectoparasiticide for extended control

(75) Inventors: Robert Bruce Albright, Chalfont, PA (US); Shobhan Shashikant Sabnis, Pennington, NJ (US); Larry A. Kraft, Hightstown, NJ (US); Susan Holzmer, Ewing, NJ (US); Robert Alan Pollet, Yardley, PA (US); Ramune Marija Cobb, Newtown, PA (US)

Correspondence Address: WYETH;PATENT LAW GROUP, 5 GIRALDA FARMS, MADISON, NJ, 07940, US

(73) Assignee: Wyeth, Madison, NJ (US)

(21) Appl. No.: 11/897,405

(22) Filed: Aug. 30, 2007

Related U.S. Application Data
(63) Continuation-in-part of application No. 11/435,684, filed on May 17, 2006.
(60) Provisional application No. 60/683,949, filed on May 24, 2005.

(51) Int. Cl. A01N 25/00

(52) U.S. Cl. 424/405

(57) ABSTRACT

The present invention provides a topical, high-dose, long-acting ectoparasiticide composition effective for protecting against ectoparasite infestation in a warm-blooded animal for a period of greater than about 6 weeks.

Also provided is a method for the extension of the duration of activity of an ectoparasitcide.

This application is a continuation-in-part application of co-pending application Ser. No. 11/435,684, filed on May 17, 2006 which claims the benefit of provisional application Ser. No. 60/683,949, filed on May 24, 2005, the entire disclosure of each application is hereby incorporated by reference.

### BACKGROUND OF THE INVENTION

Arthropod ectoparasites commonly infecting warm-blooded animals include ticks, mites, lice, fleas, blowfly, the ectoparasite Lucilia sp. of sheep, biting insects including keds (Melophagus ovinus) and migrating dipterous larvae such as Hypoderma sp. and Dermatobia in cattle, Gastrophilus in horses and Cuterebra sp. in rodents.

Metaflumizone is useful for the prevention and control of infestation by ectoparasites in warm-blooded animals. Topical administration is a preferred method for administering this compound.

To provide suitable protection against ectoparasitic infection or infestation in warm-blooded animals, it is desirable to use a topical formulation having a relatively high-dose of metaflumizone. Such a formulation has the effect of providing a formulation that is easy to apply, good spreading over skin, and avoids run-off. It is often difficult, however, to formulate such compositions for stability of the active ingredient while maintaining the desirable characteristics of the composition.

Metaflumizone is one of several useful ectoparasiticidal agents that have found particular application for the control of fleas on animals, particularly companion animals such as dogs, cats or horses. It is particularly advantageous in that it can provide 4-6 weeks of protection from fleas in companion animals, yet it would still be desirable to formulate an application that could be applied to protect the subject animal while avoiding the possibility of ingestion by the subject animal and/or run-off and waste of the active composition. Nonetheless, formulations are difficult due to the insolubility of metaflumizone in many solvents, and its instability in the presence of primary alcohols.

Like metaflumizone, other useful arthropodicidal agents known in the art, including fipronil and imidacloprid, are currently limited in the duration of protection to approximately 4-6 weeks. Current limitations are usually caused by loss of the active ingredient due to environmental or biological effects, including ruboff, photodegredation, and animal metabolism. As the flea and tick seasons persist significantly longer than 4-6 weeks in many areas, multiple doses are currently often required to achieve substantial protection from fleas and ticks for an entire season. It is, therefore, desirable to formulate applications that would offer substantial protection from fleas and ticks, as well as other arthropods, for the whole season in one application. Such applications would offer convenience and efficiency benefits, and would eliminate the risk of a gap in protection stemming from poorly-timed administration of additional doses.

Thus, what is needed in the art are ectoparasiticide compositions, which provide extended efficacy against parasitic infestations and a method to extend the duration of efficacy of an ectoparasiticide.

Therefore it is an object of this invention to provide a high-dose, long-acting topical ectoparasiticide composition which is effective for protecting against ectoparasite infestation in a warm-blooded animal for a period of greater than about 6 weeks.

It is another object of this invention to provide a method for the extension of the duration of activity of an ectoparasitcide in a warm-blooded animal.

Further objects and features of the invention will become apparent from the detailed description set forth hereinbelow.

### SUMMARY OF THE INVENTION

The present invention provides a high-dose, long-acting ectoparasiticide composition which comprises on a weight to volume basis:

(a) about 5% to 40% of metaflumizone;

(b) about 5% to 15% of a bridging agent;

(c) about 0% to 15% of a surfactant; and

(d) about 5% to 80% of a carrier solvent or a mixture of solvents.

Also provided is a method for extending the period of efficacy of an ectoparasiticide which comprises administering a high dose of said ectoparasiticide.

### DETAILED DESCRIPTION OF THE INVENTION

Many topical veterinary compositions require relatively high concentrations of active ingredients to ensure effective and long-lasting protection to the host animal and administration in sufficiently small volumes so as to avoid loss of the composition from run-off or licking by the animal. Typical “spot-on” applications of such compositions to the base of the neck of the animal aid in making the applied composition difficult for the animal to remove, but require that a relatively small volume be applied. However, the solubility of metaflumizone frequently limits the abilitly to obtain high concentrations of metaflumizone in such applications. Topical veterinary compositions containing metaflumizone as one of the active ingredients are highly desirable due to the effective and persistent activity of metaflumizone against a variety of ectoparasites, including, but not limited to, the cat flea, Ctenocephalides felis, and the dog flea, Ctenocephalides canis, in dogs or cats.

Surprisingly, it has now been found that metaflumizone may be formulated in a high-dose, long-acting, topical non-irritating composition comprising metaflumizone; a bridging agent or penetration enhancer, an optional surfactant, and a carrier solvent or mixture of solvents. Accordingly, the present invention provides a high-dose, long-acting ectoparasiticide composition which comprises on a weight to volume basis:

(a) about 5% to 40% of metaflumizone;

(b) about 5% to 15% of a bridging agent;

(c) about 0% to 15% of a surfactant; and

(d) about 5% to 80% of a carrier solvent or a mixture of solvents.

Advantageously, the composition of the invention retains the desired physical characteristics over time, without loss of potency of the active. Further, the composition of the invention exhibits sufficient viscosity, which allows for the retention of said composition when administered topically to an animal's skin or hair, and which facilitates the release of metaflumizone over the desired extended period of time.

As used in the specification and claims, the terms “about” and “approximately” designate that a value is within a statistically meaningful range. Such a range can be within an order of magnitude, typically within 50%, more typically within 20%, more typically still within 10%, and even more typically within 5% of a given value or range. The allowable variation encompassed by the terms “about” and “approximately” depends on the particular system under study, and can be readily appreciated by one of ordinary skill in the art.

As used herein, the term “w/w” designates weight/weight, the term “w/v” designates weight/volume, and the term “mg/kg” designates milligrams per kilogram of body weight. The term “a.i.” or “ai” designates active ingredient, and may be combined with other terms. For example “mg a.i./kg” designates milligrams of active ingredient per kilogram of body weight.

The term “carrier” refers to a diluent, adjuvant, excipient, preservative, and/or vehicle with which a compound or composition is administered.

Typically, high-dose, long-acting metaflumizone compositions comprise about 20% to 40% metaflumizone on a weight to volume basis. Most typically, compositions comprise metaflumizone at a concentration selected from the group consisting of: 20%; 21%; 22%; 23%; 24%; 25%; 26%; 27%; 28%; 29%; 30%; 31%; 32%; 33%; 34%; 35%; 36%; 37%; 38%; 39%; and 40% on a weight to volume basis.

Metaflumizone is known in the art by its chemical name: (E Z)-2-[2-(4-cyanophenyl)-1-[3-(trifluoromethyl)phenyl]ethylidene]-N-[4-(tri-fluoromethoxy)phenyl]hydrazinecarboxamide and is described in U.S. Pat. No. 5,543,573, and U.S. 2004/0122075A1, among other publications. The chemical structure of metaflumizone is shown below.

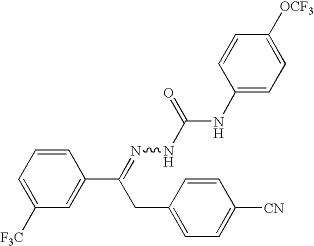

ProMeris™ is the trade name for the veterinary formulation of metaflumizone marketed by Fort Dodge Animal Health (Wyeth). ProMeris™ Spot-On for Cats is a product containing metaflumizone in a non-aqueous solution, designed as a topically applied treatment to control fleas on cats at a rate of 40 mg/kg body weight. ProMeris™ Spot-On for Dogs is a product containing metaflumizone and amitraz in a non-aqueous solution, designed as a topically applied treatment to control fleas and ticks on dogs at a rate of 20 mg/kg body weight of each active ingredient.

High-dose, long-acting compositions of the present disclosure may alternatively or additionally comprise one or more alternative ectoparasiticide agents such as, for example, imidacloprid, fipronil, amitraz, or a mixture thereof.

In certain embodiments about 5% to 15% on a weight to volume basis of a bridging agent is included in the compositions disclosed herein. Most typically, compositions comprise one or more of the bridging agent at a concentration selected from the group consisting of: 5%; 6%; 7%; 8%; 9%; 10%; 11%; 12%; 13%; 14%; and 15% on a weight to volume basis.

Bridging agents, also referred to as penetration enhancers, which are suitably employed in the compositions disclosed herein include, without limitation, alkyl methyl sulfoxides (such as dimethyl sulfoxide, decylmethyl sulfoxide and tetradecylmethyl sulfoxide); pyrrolidones (such as 2-pyrrolidone, N-methyl-2-pyrrolidone and N-(2-hydroxyethyl)pyrrolidone); laurocapram; and miscellaneous solvents such as acetone, dimethyl acetamide, dimethyl formamide, and tetrahydrofurfuryl alcohol. Other bridging agents include amphiphiles such as L-amino acids, and fatty acids. Additional bridging agents are disclosed in Remington: The Science and Practice of Pharmacy, 19th Edition (1995), on page 1583.

The composition of the invention additionally comprises about 0% to 15% of a surfactant on a weight to volume basis. Most typically, the surfactant is present at a concentration selected from the group consisting of: 0%; 1%; 2%; 3%; 4%; 5%; 6%; 7%; 8%; 9%; 10%; 11%; 12%; 13%; 14%; and 15% on a weight to volume basis.

Surfactants suitably employed in the composition of the invention include a single surfactant, or a mixture of two or more surfactants. Suitable surfactants are non-irritating and non-toxic. Exemplified herein, without limitation, are non-ionic, low foaming surfactants, such as the alcohol alkoxylate surfactants sold by Uniqema under the tradename Synperonic® NCA 810, 830 and 850. Other suitable surfactants are the nonylphenol ethoxylates, such as those sold under the tradename Tergitol®NP by the Dow Chemical Company. Additional surfactants, including appropriately chosen anionic and cationic surfactants, can also be utilized in the composition of the present invention. Especially useful properties are found in anionic surfactants, such as dioctylsulfosuccinate salts. Particularly effective surfactants for use with an organic carrier solvent are non-ionic surfactants such as polyoxyl 35 castor oil sold under the Cremophor® trade name.

The inventive composition may also comprise one or more carrier solvents which may be present at about 5% to 80% on a weight to volume basis. Most typically, the carrier solvent or mixture of solvents is present at a concentration selected from the group consisting of: about 5% to 45%; about 50%; about 55%; about 60%; about 65%; about 70%; about 75%; and about 80% on a weight to volume basis.

Carrier solvents that may be suitably employed in the composition of the invention include single solvents, or a mixture of two or more solvents. Due to the instability of metaflumizone in the presence of primary alcohols, preferred solvents are non-hydroxyl-group-containing solvents, especially those such as γ-hexylactone (also known as γ-caprolactone; ethyl butyrolactone; γ-ethyl-n-butyrolactone; hexanolide-1,4; 4-hydroxy hexanoic acid γ-lactone or tonkalide), 6-hexylactone, γ-butyrolactone etc. γ-Hexylactone, Synperonic NCA 830, and dimethyl sulfoxide are employed within some embodiments of the present invention. Within other embodiments, solvents such as N,N-diethyl-m-toluamide, eucalyptol, dimethyl isosorbide, diisopropyl adipate and/or 1-methoxy-2-propyl acetate may be advantageously utilized in combination with the γ-hexylactone to comprise the carrier solvent mixture. Suitable pharmaceutical carriers are described in “Remington's Pharmaceutical Sciences” by E. W. Martin, 18^{th} Edition. A wide variety of carriers are readily available and the selection of specific carriers is well within the level of those skilled in the art.

To manufacture a high-dose, long-acting metaflumizone composition of the present invention, the metaflumizone may be dissolved in the carrier solvent or solvents, and the surfactant and bridging agent, if desired, added to the metaflumizone/carrier solvent solution. These compositions may then be utilized as a high-dose, long-acting spot-on for topical application or may be further diluted for alternative uses. Compositions are most suitably formulated as creams, gels, solutions, or in microspheres.

An exemplary composition for topical administration to warm-blooded animals typically comprises, on a weight to volume basis, about 5%-40% w/v metaflumizone; about 10% w/v of a bridging agent, such as dimethyl sulfoxide; about 0%-8% w/v of a non-ionic, low foam surfactant; and about 45%-60% of a carrier solvent or solvent mixture, such as γ-hexylactone by itself or in combination with about 10% w/v of N,N-diethyl-m-toluamide, about 10% w/v of eucalyptol and about 20% w/v of 1-methoxy-2-propyl acetate.

High-dose, long-acting metaflumizone compositions of the invention may further comprise other agents known in the art, such as preservatives (e.g., methylparaben and propylparaben), colorants, antioxidants, or the like. Generally, these agents are present in the composition in an amount up to about 2% on a weight to volume basis. Preservatives may include, for example, thiomersal, EDTA, or the like.

Suitable exemplary polymers for gelling agents that may be used in the compositions of the invention include, but are not limited to, colloidal silicone dioxide, ethyl cellulose, methyl cellulose, methacrylic esters copolymers, carboxylated vinyl acetate terpolymer, and polyvinylpropylene (PVP)Ninyl acetate copolymers. “Gantrez”® is the trade name for a family of polyvinylmethylether formulations (as solutions, creams, powders, etc.) manufactured by International Specialty Products, of Wayne, N.J. Gantrez powder formulations comprise poly(vinylmethylether/maleic anhydride). Gantrez cream formulations comprise ethyl or butyl esters of polyvinylmethylether/maleic anhydride copolymer and ethyl or butyl esters of PVM/MA copolymer.

Carbopol® is the trade name of exemplary carbomers used in the formulation of certain embodiments of the presently disclosed compositions. Other acrylic acid polymers other than carbomers may be used, though carbomers may be employed.

In those embodiments in which high-dose, long-acting metaflumizone compositions are formulated as microspheres, polymers including, but not limited to, sulfopolyester (AQ55S polymer from Eastman Chemical Co., Kingsport, Term., USA; typical repeating units of these polymers are disclosed in column 7 of U.S. Pat. No. 5,260,052.), and cellulose acetate butyrate (CAB), poly(lactide-co-glycolide) (PLGA) may be employed. Alternatively, microsphere formulation may employ one or more of polylactic galactide, hollow microspheres such as Expancel (Nobel Industrie), Polytrap (Dow Corning), and hollow silica microspheres (Silica Beads from Maprecos).

Advantageously, the ectoparasiticidal topical veterinary composition of the invention allows for high concentrations of the active ingredients and demonstrates no irritation to the skin/hide/hair of the host animal. Accordingly, the present invention provides a method for the treatment of an ectoparasiticidal infection or infestation in a warm-blooded animal which comprises topically administering to said animal a composition which comprises an effective amount of metaflumizone; a bridging agent or penetration enhancer, an optional surfactant, and a carrier solvent or mixture of solvents.

When topically administered, the high-dose, long-acting metaflumizone composition of the invention is highly effective for preventing or mitigating ectoparasitic infection and/or infestation for prolonged periods of time in warm-blooded animals such as swine, cattle, sheep, horses, goats, camels, water buffalo, bison, donkeys, rabbits, kangaroos, fallow deer, reindeer, minks, chinchillas, raccoons, chicken, geese, turkeys, ducks, dogs, cats, or the like, preferably dogs, cats, swine, cattle, horses or sheep, and most preferably cats or dogs.

Examples of topical administrations suitable for use in the method of the invention include spot-on, pour-on, dip, wash, shampoo, foam, gel, lotion, cream, microsphere-encapsulated formulation, powder, or any of the conventional means of topically applying a liquid or semi-liquid veterinary composition. The topical mode of administration will vary with the species and size of the host animal. As an example, for companion animals such as dogs or cats, a spot-on, gel, cream, powder, or microsphere-encapsulated formulation, and most preferably a spot-on, may be suitable. For large agronomic animals such as cattle, horses or sheep, a pour-on or spray, most preferably a pour-on, may be suitable.

Ectoparasitic infection or infestations suitable for treatment by the methods of the invention include fleas, ticks, lice, mites and flies. In particular, the methods and kits of the present invention are suitable for treating or preventing flea infestations, and even more particularly, infestations of the cat flea, Ctenocephalides felis and the dog flea, Ctenocephalides canis.

In actual practice, the composition of the invention may be administered in dose rates of mg of active ingredient per kg of body weight of the host animal. As will be understood by those skilled in the art, dose rates suitable for use in the method of invention will vary depending upon the identity of the ectoparasiticide, the mode of administration, the species and health of the host animal, the target parasite, the degree of infection or infestation, the breeding habitat, the potency of the additional parasiticidal compound, or the like.

For dogs, a dose of metaflumizone of about 30-120 mg per kg of body weight may be administered. More typically, a dose of metaflumizone will be about 35-100 mg per kg of body weight or about 40-80 mg metaflumizone per kg of body weight.

For cats, a dose of metaflumizone of about 60-240 mg per kg of body weight may be administered. More typically, a dose of metaflumizone will be about 70-160 mg per kg of body weight or about 80-160 mg metaflumizone per kg of body weight.

Typical “spot-on” applications of exemplary embodiments of the invention are applied to the base of the neck of the animal or generally along the dorsal midline in the area between the shoulder blades, so as to aid in making the applied composition difficult for the animal to remove.

Surprisingly, it has now been found that dosages of two to three times the conventional dose rates of an ectoparasiticide in topical formulations offer substantially longer effective protection against ectoparasites in warm-blooded animals, including both dogs and cats. Accordingly the present invention provides a method for extending the period of efficacy of an ectoparasiticide which comprises administering a high dose of said ectoparasiticide. High doses suitable for use in the method of the invention include dose rates of about 2 to 3 times the conventional dose rate for said ectoparasiticide. Beneficially, the method of the invention provides protection from ectoparasitic infestation for an extended period of time compared to presently available commercial formulations. The extended period of efficacy obtained by the method of the invention may be greater than about 6 weeks and may be about 6-20 weeks of extended efficacy.

As used in the specification and claims, the term “conventional dose rate” designates that dose rate which is disclosed and taught in the art for any one specific ectoparasiticide, i.e. the art-recognized dose rate.

In one embodiment of the invention, for dogs or cats, a dose of imidacloprid of about 15-60 mg per kg of body weight may be administered. More typically, a dose of imidacloprid of about 20-50 mg per kg of body weight may be administered to obtain extended efficacy against ectoparasites of about six week or greater.

In another embodiment of the invention, for dogs or cats, a dose of fipronil of about 10-50 mg per kg of body weight may be administered. More typically, a dose of fipronil of about 15-35 mg per kg of body weight may be administered to obtain protection from ectoparasitic infestation for an extended period of time compared to presently available commercial formulations.

Topical administration of a high dose, such as 2-3 times the conventional dose, of compositions and formulations containing ectoparasiticides such as metaflumizone, fipronil, imidacloprid or the like, or a mixture thereof are suitable for use in the method of the invention for the long-term protection of warm-blooded animals against ectoparasital infection or infestation. Advantageously, the method of the invention increases the period of time for effectively reducing or controlling the proliferation of acarid or arthropod ectoparasites.

For a more clear understanding of the invention, the following examples are set forth hereinbelow. These examples are merely illustrative and are not understood to limit the scope or underlying principles of the invention in any way. Indeed, various modifications of the invention, in addition to those shown and described herein, will become apparent to those skilled in the art from the examples set forth hereinbelow and the foregoing description. Such modifications are also intended to fall within the scope of the appended claims.

Unless otherwise designated, all parts are parts by weight. The term qs designates quantity sufficient to obtain a total of 100%. The term DMSO designates dimethyl sulfoxide.

### EXAMPLE 1

### Preparation of a Metaflumizone High-Dose, Long-Acting Concentrate Composition, Suitable for Use as a Spot-On Treatment

| | A | B | C |
|---|---|---|---|
| Ingredients | (% w/v) | (% w/v) | (% w/v) |
| Metaflumizone | 30 | 30 | 20 |
| Synperonic NCA 830 | 5 | 5 | 5 |
| DMSO | 10 | 10 | 10 |
| Resyn ® 29-2930 | — | 5 | — |
| γ-hexalactone | qs | qs | qs |

Composition A

To 10 grams of DMSO was added 40 grams of γ-hexylactone. To this solvent mixture was added 30 g of metaflumizone. Mild heat (40° C.) was used to facilitate the process of dissolution. To the resulting solution, 5 grams of Synperonic® NCA 830 brand of alcohol alkoxylate surfactant was added with stirring. This solution was brought to a final volume of 100 ml with γ-hexylactone.

Composition B

To 10 grams of DMSO is added 40 grams of γ-hexylactone. To this solvent mixture is added 30 g of metaflumizone. Mild heat (40° C.) is used to facilitate the process of dissolution. To the resulting solution, 5 grams of Synperonic® NCA 830 brand of alcohol alkoxylate surfactant is added with stirring. To this is added 5 g of Resyn® 28-2930 brand of polymer and the mixture is stirred to dissolve the solids. This solution is brought to a final volume of 100 ml with γ-hexylactone.

Composition C

Using essentially the same procedure described hereinabove for composition A, composition C was prepared.

Compositions A, B and C are applied as a “spot-on” treatment for cats or dogs.

### EXAMPLE 2

### Preparation of a Metaflumizone High-Dose, Long-Acting Concentrate Composition, Suitable for Use as a Spot-On Treatment

| Ingredients | (% w/v) |
|---|---|
| Metaflumizone | 30 |
| DMSO | 10 |
| N,N-Diethyl-m-toluamide | 10 |
| Eucalyptol | 10 |
| 1-Methoxy-2-propyl acetate | 20 |
| γ-hexalactone | qs |

To 10 grams of DMSO were added 10 grams of N,N-diethyl-m-toluamide, 10 grams of eucalyptol, 20 grams of 1-methoxy-2-propyl acetate and 20 grams of γ-hexylactone. To this solvent mixture was added 30 g of metaflumizone. The resultant mixture was stirred by mechanical means to facilitate dissolution. This resulting solution was brought to a final volume of 100 ml with γ-hexylactone.

### This composition was applied as a “spot-on” treatment for cats or dogs.

### EXAMPLE 3

### Evaluation of the Efficacy of Test Compositions Against the Cat Flea, Ctenocephalides felis, in Cats

In this evaluation, domestic shorthair cats of mixed sex, aged approximately 4 years, were used. Cats were free of ectoparasiticide treatment for 60 days prior to administration of the Test Compositions. No drugs, baths, shampoos, or pesticides were given to the cats during the preconditioning phase or during the course of the study other than what is described in the protocol. The cats were preconditioned for 13 days. On day −13, each cat was infested with 100 unfed cat fleas, Ctenocephalies felis. On Day −12, each cat was thoroughly examined and combed to remove and count fleas. The cats were ranked in descending order by flea count. From this ranking, cats were blocked into three groups. The cats within each of the three blocks were randomly allocated to treatment groups (A-G). The cats were weighed on Day −1 and received one of the treatments presented in Table 1.

TABLE 1
Flea Treatments Applied to Cats

| | Number | | Application | Dose mg |
|---|---|---|---|---|
| Group | of cats | Treatment¹ | Rate, ml/kg | ai/kg BW |
| A | 3 | Untreated | 0 | 0 |
| B | 3 | 30% w/v Metaflumizone, 5% polymer | 0.27 | 80 |
| C | 3 | 30% w/v Metaflumizone, 1% polymer | 0.27 | 80 |
| D | 3 | 20% w/v Metaflumizone, 5% polymer | 0.2 | 40 |
| E | 3 | 20% w/v Metaflumizone, 1% polymer | 0.2 | 40 |
| F | 3 | 30% w/v Metaflumizone, 0% polymer | 0.27 | 80 |
| G | 3 | 20% w/v ProMeris ™ Spot on | 0.2 | 40 |

¹The “polymer” used in the treatments listed in Table 1 was Resyn 28-2930, available from National Starch and Chemical. Other excipients used in the above formulations were Synperonic NCA830, gamma hexalactone GMP04-15, and DMSO, Sigma-Aldrich.

Applications for groups B-G were administered using a disposable pipette. The dose was applied as a single spot on the dorsal neck at the base of the skull. Group A was left untreated. The cats were observed for any immediate reactions to the treatments, and were observed for post-treatment adverse reactions, skin irritation, and behavior of test formulations at the time of treatment, after approximately four hours, and on Days 1 and 2 following administration of the treatments. Thereafter, cats were observed once daily for the remainder of the study.

Cats were infested with 100 adult cat fleas on Day −1, then examined for live fleas on Day 2 to determine knockdown. The cats were reinfested on Day 13 then examined for fleas on Day 15. The cats were reinfested and examined yet again on Days 27 and 29, then monthly until efficacy waned.

At each infestation, 100 unfed adult fleas were applied along the dorsal rump of each cat. The negative control group (Group A) was infested before the test compound groups. Fleas were recovered by examining and combing the groups in the same order. Combs were washed and rinsed with alcohol between cats, and latex gloves were changed between treatment groups.

Flea counts were transformed by log(count+1), and geometric means were used to calculate percent efficacy for the treatments using (Yc−Yt)/Yc*100, where Yc and Yt equal mean counts for control and treated groups, respectively.

The results are shown in Table 2 hereinbelow. As shown in Table 2, of the formulations tested in this study, the high-dosage metaflumizone formulation with no polymer (Group F) offered the best long-term protection against fleas—providing very high efficacy (94.1%) at Day 85, and higher efficacy at Day 113 (74.9%) than most other formulations exhibited at Day 85.

TABLE 2
Average Flea Comb Counts for Cats Administered
Various Test Compositions

| Tr. | | | Day | Day | Day | Day | Day | Day |
|---|---|---|---|---|---|---|---|---|
| Group¹ | | Day-12 | 2¹ | 15 | 29 | 57 | 85 | 113 |
| A | G.M. | 52.5 | 53.9 | 83.9 | 62.9 | 65.2 | 74.0 | 66.9 |
| B | G.M. | 55.8 | 1.9 | 0.7 | 0.0 | 10.1 | 27.7 | NT² |
| | % | | 96.5 | 99.2 | 100.0 | 84.5 | 62.5 | NT |
| | Efficacy | | | | | | | |
| C | G.M. | 51.2 | 0.8 | 0.3 | 0.8 | 2.6 | 15.9 | |
| | % | | 98.5 | 99.7 | 98.7 | 96.1 | 78.5 | NT |
| | Efficacy | | | | | | | |
| D | G.M. | 53.9 | 10.5 | 0.6 | 5.5 | 23.3 | 44.3 | |
| | % | | 80.4 | 99.3 | 91.3 | 64.3 | 40.2 | NT |
| | Efficacy | | | | | | | |
| E | G.M. | 59.9 | 0.3 | 0.0 | 1.5 | 4.1 | 36.4 | |
| | % | | 99.5 | 100.0 | 97.6 | 93.7 | 50.9 | NT |
| | Efficacy | | | | | | | |
| F | G.M. | 55.1 | 0.6 | 0.3 | 0.0 | 0.36 | 4.3 | 16.8 |
| | % | | 98.9 | 99.7 | 100.00 | 99.1 | 94.1 | 74.9 |
| | Efficacy | | | | | | | |
| G | G.M. | 58.8 | 0.0 | 0.0 | 0.0 | 1.9 | 14.8 | |
| | % | | 100.0 | 100.0 | 100.0 | 97.1 | 80.0 | NT |
| | Efficacy | | | | | | | |

¹Treatments:
A = untreated;
B = 30% w/v metaflumizone, 5% polymer, at 80 mg/kg
C = 30% w/v Metaflumizone, 1% polymer, at 80 mg/kg
D = 20% w/v Metaflumizone, 5% polymer, at 40 mg/kg
E = 20% w/v Metaflumizone, 1% polymer, at 40 mg/kg
F = 30% w/v Metaflumizone, 0% polymer, at 80 mg/kg
G = 20% w/v ProMeris ™ Spot-on, at 40 mg/kg
²NT = not tested

### These data demonstrate the surprising long-term efficacy of novel high-dosage metaflumizone formulations in the treatment of cat fleas in cats.

### EXAMPLE 4

### Evaluation of the Efficacy of Test Compositions Against the Cat Flea, Ctenocephalides felis, in Dogs

In this evaluation, Beagles weighing not more than 10 kg, aged one to 10 years, were used. Dogs were free of ectoparasiticide treatment for 60 days prior to administration of the long-acting formulations. No drugs, baths, shampoos or pesticides were given to the dogs during the preconditioning phase or during the course of the study other than what is described in the protocol. The dogs were preconditioned for 14 days. All dogs were bathed with a noninsecticidal shampoo between Days −12 to −10. On Day −7, each dog was infested with 100 unfed cat fleas, Ctenocephalides felis. On Day −6, each dog was thoroughly examined and then combed to remove and count fleas. Dogs were selected for inclusion on the basis of flea retention and/or behavior. The dogs with the highest flea counts were selected for the study. Dogs retained at least 30 fleas to be included in the present study. The animals were blocked by flea number retained into three blocks. Within blocks, the dogs were randomly allocated into groups (A-J) of 3 dogs each. The selected dogs were weighed on Day −1 and received flea treatments on Day 0. The five treatment groups included in this example are presented in Table 3, wherein the column headed n is the number of animals.

TABLE 3
Flea Treatments Applied to Dogs

| | | | Application | | Dose |
|---|---|---|---|---|---|
| Group | n | Treatment | Rate | | (mg/kg) |
| A | 3 | Control - No treatment | 0.00 | | 0 |
| B | 3 | 30% w/v metaflumizone spot-on | 0.20 | ml/kg | 60 |
| H | 3 | 30% w/w metaflumizone/Gantrez | .02 | g/kg | 60 |
| | | powder | | | |
| I | 3 | 6% w/w metaflumizone/Gantrez | 1.0 | g/kg | 60 |
| | | complex in a suspension | | | |
| J | 3 | 30% w/v metaflumizone cat | 0.20 | ml/kg | 60 |
| | | spot-on with 5% polymer | | | |

Groups B and J received a spot to the skin (by syringe) at the dorsal midline between the shoulder blades. The metaflumizone/Gantrez powder (Group H) and metaflumizone/Gantrez complex suspension (Group I) were applied (poured or shaken from an appropriate container) directly to the skin along the back and rubbed onto the skin using a gloved finger. Group A was left untreated. All metaflumizone treatments were at dosed at 60 mg/kg. The dogs were observed for any immediate reactions to the treatments. Observations of the behavior and characteristics of the formulations were noted, with observations for post-treatment adverse reactions, skin irritation and behavior of test formulations made at approximately 4 and 24 hours following the administration of treatments. Thereafter, dogs were observed once daily on Days 2-14 for formulation acceptability, adverse reactions or signs of skin irritation following treatment. Daily observations of the physical condition of the dogs were made throughout the trial, in part to monitor for distress or injury.

Dogs were infested with 100 adult cat fleas on Day 14 and then examined for live fleas on Day 16. The dogs were reinfested on Day 28 and examined for fleas on Day 30, and then reinfested periodically for up to five months after treatment depending upon the flea control activity observed. At each infestation, 100 unfed adult fleas were applied along the lateral midline of each dog. The negative control group (Group A) was infested before the test compound groups. Fleas were recovered by examining and combing the groups in the same order. Combs were washed and rinsed with alcohol between dogs. Plastic gloves and aprons were changed between treatment groups.

Flea counts were transformed by log(count+1), and geometric means were used to calculate percent efficacy for the treatments using (Yc−Yt)/Yc*100, where Yc and Yt equal mean counts for control and treated groups, respectively. The results are shown in Table 4 hereinbelow, wherein the column headed n represents the number of animals.

As shown in Table 4, dogs treated with 30% metaflumizone spot-on formulation at 60 mg/kg (Group B) were almost completely protected (97.7% efficacy) from fleas at Day 114, and protected with 72.1% efficacy at Day 142. Overall, the spot-on formulations (Groups B and J) performed significantly better than other high-dose powder or suspension formulations tested (Groups H and I).

TABLE 4
Average Flea Comb Counts for Dogs Administered
Various Test Compositions

| | | Flea Counts/Dog (Geometric Means)¹ | | | | | | | |
|---|---|---|---|---|---|---|---|---|---|
| | | Day | Day | Day | Day | Day | Day | Day | Day |
| Group | n | 16 | 30 | 58 | 86 | 100 | 114 | 128 | 142 |
| A | 3 | 63.8 | 71.1 | 65.1 | 69.1 | 66.9 | 70.3 | 77.6 | 74.6 |
| B | 3 | 0.0 | 0.0 | 0.0 | 1.9 | 1.5 | 1.6 | 9.0 | 20.8 |
| | % E² | 100.0 | 100.0 | 100.0 | 97.3 | 97.8 | 97.7 | 88.4 | 72.1 |
| H | 3 | 0.3 | 0.3 | 14.0 | 23.1 | NT | NT | NT | NT |
| | % E² | 99.7 | 99.7 | 78.5 | 66.5 | | | | |
| I | 3 | 0.0 | 1.4 | 4.4 | 21.9 | NT | NT | NT | NT |
| | % E² | 100.0 | 98.6 | 93.2 | 68.3 | | | | |
| J | 3 | 0.0 | 0.0 | 0.3 | 9.8 | 5.0 | 8.1 | NT | NT |
| | % E² | 100.0 | 100.0 | 99.6 | 85.7 | 92.5 | 88.4 | | |

¹NT = Not tested.
²% Efficacy
Treatments:
A = untreated
B = 30% Metaflumizone Spot-On
H = 30% Metaflumizone/Gantrez Powder
I = 6% Metaflumizone/Grantrez Complex Suspension
J = 30% Metaflumizone Spot-On w/5% polymer

### EXAMPLE 5

### Evaluation of the Duration of Efficacy of High Doses (2× and 3× the Monthly Dose) of Ectoparasiticides Against the Cat Flea, Ctenocephalides felis, in Cats

In this evaluation, 32 domestic shorthair cats of mixed sex, aged at least 6 months, were used to test the high doses of ectoparasiticides disclosed herein. Cats were free of ectoparasiticide treatment for 60 days prior to administration of the experimental treatments. No drugs, baths, shampoos, or pesticides were given to the cats during the preconditioning phase or during the course of the study other than what is described in the protocol. At least 36 cats were preconditioned for 7 days. On day −7, each cat was infested with 100 unfed cat fleas, Ctenocephalies felis. On Day −5, each cat was thoroughly examined and combed to remove and count fleas. 32 cats were ranked in descending order by flea count. From the ranking, the cats were divided into four blocks of eight cats each. The eight cats within each of the four blocks were randomly allocated to treatment groups (A-H). The cats were weighed on Day −1 and received one of the treatments presented in Table 5.

TABLE 5
Flea Treatments Applied to Cats

| | Number | | Application Rate, | Dose |
|---|---|---|---|---|
| Group | of Cats | Treatment | ml/kg | mg/kg |
| A | 4 | Nontreated | 0 | 0 |
| B | 4 | 20% w/v Metaflumizone | 0.200 | 40 |
| C | 4 | 30% w/v Metaflumizone | 0.270 | 80 |
| D | 4 | 30% w/v Metaflumizone | 0.400 | 120 |
| E | 4 | 10% w/v fipronil* | 0.075 | 7.5 |
| F | 4 | 10% w/v fipronil* | 0.225 | 22.5 |
| G | 4 | 10% w/v imidacloprid** | 0.100 | 10 |
| H | 4 | 10% w/v imidacloprid** | 0.300 | 30 |

*The fipronil formulation used in the present Example was Frontline ®, as sold by Merial Limited (Duluth, GA)
**The imidacloprid formulation used in the present Example was Advantage ® as sold by Bayer Corporation (Shawnee Mission, KS)

Applications for groups B-H were administered using a disposable syringe. The dose was applied as a single spot on the dorsal neck at the base of the skull. Group A was left untreated. The cats were observed for any immediate reactions to the treatments, and were observed for post-treatment adverse reactions, skin irritation, and behavior of test formulations at the time of treatment, after approximately four hours. On Days 1 through 14 following administration of the treatments, cats were observed daily for reactions and formulation acceptability. Thereafter, cats were observed once daily for the remainder of the study. Cats were infested with 100 adult cat fleas on Day 14 then examined for fleas on Day 16. The cats were re-infested and examined again on Days 28 and 30, on Days 56 and 58 then bi-weekly until efficacy waned. At each infestation, 100 unfed adult fleas were applied along the dorsal rump of each cat. The negative control group (Group A) was infested before the test compound groups. Fleas were recovered by examining and combing the groups in the same order. Combs were washed and rinsed with alcohol between cats, and latex gloves were changed between treatment groups.

Flea counts were transformed by log(count+1), and geometric means were used to calculate percent efficacy for the treatments using (Yc−Yt)/Yc*100, where Yc and Yt equal mean counts for control and treated groups, respectively. The results are shown in Table 6 hereinbelow.

As shown in Table 6, cats treated with higher doses (2× or 3× the standard dosage) of the three ectoparasiticides tested (metaflumizone, fipronil, and imidacloprid) experienced sustained protection from fleas for longer periods of time compared to cats treated with standard doses.

TABLE 6
Average Flea Comb Counts for Cats Administered High-Dose Rates of
Metaflumizone, Fipronil, or Imidacloprid

| Treatment | | Day | Day | Day | Day | Day | Day |
|---|---|---|---|---|---|---|---|
| Group | | 16 | 30 | 58 | 72 | 86 | 100 |
| A Untreated | G.M. | 52.5 | 63.4 | 54.1 | 66.3 | 57.9 | 59.0 |
| B | G.M. | 1.3 | 3.2 | 13.7 | 9.8 | 27.2 | 43.3 |
| 20% | % | 97.4 | 94.9 | 74.7 | 85.2 | 53.1 | 26.5 |
| metaflumizone | Efficacy | | | | | | |
| 40 mg/kg | | | | | | | |
| C | G.M. | 0.9 | 3.9 | 14.4 | 9.4 | 24.4 | 31.9 |
| 30% | % | 98.3 | 93.9 | 73.4 | 85.8 | 57.8 | 45.9 |
| metaflumizone | Efficacy | | | | | | |
| 80 mg/kg | | | | | | | |
| D | G.M. | 0.0 | 0.7 | 0.3 | 1.1 | 1.4 | 15.9 |
| 30% | % | 100.0 | 98.9 | 99.4 | 98.4 | 97.5 | 73.1 |
| metaflumizone | Efficacy | | | | | | |
| 120 mg/kg | | | | | | | |
| E | G.M. | 1.2 | 2.3 | 11.5 | 12.5 | 19.2 | 50.6 |
| 7.5 mg | % | 97.7 | 96.4 | 78.8 | 81.1 | 66.9 | 14.3 |
| fipronil*/kg | Efficacy | | | | | | |
| F | G.M. | 1.2 | 0.0 | 3.4 | 3.5 | 20.3 | 40.4 |
| 22.5 mg | % | 97.8 | 100.0 | 93.8 | 94.7 | 64.9 | 31.5 |
| fipronil*/kg | Efficacy | | | | | | |
| G | G.M. | 0.0 | 1.0 | 10.0 | 10.0 | 16.7 | 33.3 |
| 10 mg | % | 100.0 | 98.5 | 81.4 | 84.8 | 71.1 | 43.5 |
| imidacloprid**/kg | Efficacy | | | | | | |
| H | G.M. | 0.0 | 0.3 | 0.0 | 0.7 | 2.3 | 5.1 |
| 30 mg | % | 100.0 | 99.5 | 100.0 | 99.0 | 96.0 | 91.4 |
| imidacloprid/kg | Efficacy | | | | | | |

*The fipronil formulation used in the present Example was Frontline ®, as sold by Merial Limited (Duluth, GA)
**The imidacloprid formulation used in the present Example was Advantage ® as sold by Bayer Corporation (Shawnee Mission, KS)

### EXAMPLE 6

### Evaluation of the Duration of Control in Dogs Treated with Ectoparasiticides at Up to 3× the Monthly Dose Against the Cat Flea, Ctenocephalides felis

In this evaluation, 32 mixed breed male or female dogs, aged 1 to 10 years, were used. Dogs were not treated with an ectoparasiticide for 60 days prior to the study. No drugs, baths, shampoos or pesticides were given to the dogs during the preconditioning phase or during the course of the study other than what is described in the protocol. At least 36 dogs were preconditioned for 14 days. All dogs were bathed with noninsecticidal shampoo (Day −12 to −8). On Day −7, each dog was infested with 100 unfed cat fleas, Ctenocephalides felis. On Day −5, each dog was thoroughly examined and then combed to remove and count fleas. Dogs were selected for inclusion in the study on the basis of flea retention and/or behavior. The 32 dogs with the highest flea counts were selected for the study, except for exclusion of dogs deemed not easily handled. The dogs were blocked by flea number retained, and randomly allocated within blocks into 8 groups of 4 dogs. The selected dogs were weighed on Day −1 and received one of the flea treatments presented in Table 7.

TABLE 7
Flea Treatments Applied to Dogs

| | Number | | Application | Dose |
|---|---|---|---|---|
| Group | of Dogs | Treatment | Rate (ml/kg) | (mg/kg) |
| A | 4 | Control - No treatment | 0.0 | 0 |
| B | 4 | 15% Metaflumizone | 0.13 | 20 |
| C | 4 | 30% Metaflumizone | 0.40 | 120 |
| D | 4 | 30% Metaflumizone | 0.20 | 60 |
| E | 4 | 10% imidacloprid** | 0.10 | 10 |
| F | 4 | 10% imidacloprid** | 0.30 | 30 |
| G | 4 | 10% fipronil* | 0.07 | 7 |
| H | 4 | 10% fipronil* | 0.21 | 21 |

*The fipronil formulation used in the present Example was Frontline ®, as sold by Merial Limited (Duluth, GA)
**The imidacloprid formulation used in the present Example was Advantage ® as sold by Bayer Corporation (Pittsburgh, PA)

Applications for Groups B-H were administered using disposable syringes.

Each dog received a spot of the appropriate formulation to the skin (by syringe without a needle) at the dorsal midline between the shoulder blades. Group A was left untreated. The dogs were observed for any immediate reactions to the treatments. Observations for post-treatment adverse reactions, skin irritation and behavior of test formulations were made at four hours following administration of treatments. Thereafter, dogs were observed once daily on Days 1-14 for formulation acceptability, adverse reactions, or signs of skin irritation following treatment. Daily observations of the physical condition of the animals were made throughout the trial. Dogs were infested with 100 adult cat fleas, Ctenocephalides felis, on Day 14 and then examined for live fleas on Day 16. The dogs were re-infested/examined on Days 28/30, 56/58, 70/72, 84/86 and then infested and examined again at 2 week intervals until efficacy waned. At each infestation, 100 unfed adult fleas were applied along the lateral midline of each dog. The negative control group (Group A) was infested before the test compound groups. Fleas were recovered by examining and combing the groups in the same order. Combs were washed and rinsed with alcohol between dogs. Plastic gloves and aprons were changed between treatment groups.

Flea counts were transformed by log(count+1), and geometric means were used to calculate percent efficacy for the treatments using (Yc−Yt)/Yc*100, where Yc and Yt equal mean counts for control and treated groups, respectively. The results are shown in Table 8 hereinbelow.

As shown in Table 8, the formulation providing the 3×(60 mg/kg) dosage (Group D) of metaflumizone was substantially more effective at Days 86, 100, 114 and 128 compared to the 1×(20 mg/kg; Group B was not tested on Days 114 and 128 due to low efficacy on prior days) dosage; the 3× dosage of metaflumizone was 96.5% effective at day 128. Similarly, the 3×(30 mg/kg, Group F) dosage of imidacloprid was substantially more effective at Days 72, 86, 100, 114 and 128 compared to the 1×(10 mg/kg, Group E) dosage; the 3× dosage of imidacloprid was 94.5% effective at Day 128.

TABLE 8
Average Flea Comb Counts for Dogs Administered High Dose Rates of
Metaflumizone, Fipronil, or Imidacloprid

| | | Flea Counts/Dog/Day (Geometric Means) | | | | | | | |
|---|---|---|---|---|---|---|---|---|---|
| Group¹ | n | 16 | 30 | 58 | 72 | 86 | 100 | 114 | 128 |
| A Untreated Control | 4 | 79.8 | 85.2 | 81.0 | 77.8 | 87.2 | 72.9 | 67.0 | 46.3 |
| B 15% MTF Spot-On | 4 | 0.0 | 0.2 | 4.2 | 10.8 | 35.9 | 35.9 | NT² | NT |
| 20 mg/kg (1X) | % | 100.0 | 99.8 | 94.8 | 86.1 | 58.8 | 50.8 | — | — |
| | Efficacy | | | | | | | | |
| C 30% MTF Spot-On | 4^{a} | 0.0 | 0.0 | 0.0 | 2.3 | 13.2 | 14.8 | 29.4 | NT |
| 120 mg/kg (6X) | % | 100.0 | 100.0 | 100.0 | 97.1 | 84.9 | 79.7 | 56.2 | — |
| | Efficacy | | | | | | | | |
| D 30% MTF Spot-On | 4 | 0.0 | 0.0 | 2.5 | 0.6 | 1.3 | 1.4 | 1.2 | 1.6 |
| 60 mg/kg (3X) | % | 100.0 | 100.0 | 96.9 | 99.3 | 98.5 | 98.1 | 98.3 | 96.5 |
| | Efficacy | | | | | | | | |
| E 10 mg | 4 | 0.0 | 0.0 | 1.5 | 15.4 | 9.7 | 15.8 | 31.7 | NT |
| imidacloprid**/kg | % | 100.0 | 100.0 | 98.1 | 80.3 | 88.9 | 78.3 | 52.6 | — |
| | Efficacy | | | | | | | | |
| F 30 mg | 4^{a} | 0.0 | 0.0 | 0.0 | 2.4 | 3.1 | 2.3 | 2.3 | 2.5 |
| imidacloprid**/kg | % | 100.0 | 100.0 | 100.0 | 97.0 | 96.4 | 96.8 | 96.6 | 94.5 |
| | Efficacy | | | | | | | | |
| G 7 mg fipronil*/kg (1X) | 4 | 0.2 | 0.2 | 0.0 | 2.4 | 2.3 | 4.3 | 10.2 | NT |
| | % | 99.8 | 99.8 | 100.0 | 96.9 | 97.4 | 94.1 | 84.7 | — |
| | Efficacy | | | | | | | | |
| H 21 mg fipronil*/kg | 4 | 0.0 | 0.0 | 7.5 | 11.4 | 45.3 | 44.1 | NT | NT |
| (3X) | % | 100.0 | 100.0 | 90.7 | 85.4 | 48.0 | 39.5 | — | — |
| | Efficacy | | | | | | | | |

¹MTF = Metaflumizone
²NT = Not tested.
^{a}One dog died. N = 3 after Day 30.
*The fipronil formulation used in the present Example was Frontline ®, as sold by Merial Limited (Duluth, GA)
**The imidacloprid formulation used in the present Example was Advantage ® as sold by Bayer Corporation (Pittsburgh, PA)

What is claimed is:

1. A high-dose, long-acting ectoparasiticide composition which comprises on a weight to volume basis:
(a) about 5% to 40% of metaflumizone;
(b) about 5% to 15% of a bridging agent;
(c) about 0% to 15% of a surfactant; and
(d) about 5% to 80% of a carrier solvent or a mixture of solvents.

2. The composition according to claim 1 wherein said metaflumizone is present at about 20% to 40% on a weight to volume basis.

3. The composition according to claim 2 wherein said bridging agent is present at about 5% to 15% on a weight to volume basis.

4. The composition according to claim 3 wherein said bridging agent is selected from the group consisting essentially of: an alkyl methyl sulfoxide; a pyrrolidone; a laurocapram; a solvent; and a mixture thereof.

5. The composition according to claim 3 wherein said bridging agent is an L-amino acid or a fatty acid.

6. The composition according to claim 3 wherein said surfactant is selected from the group consisting essentially of: an alcohol alkoxylate surfactant; a nonylphenol ethoxylate; an anionic or cationic surfactant; and a non-ionic surfactant.

7. The composition according to claim 4 wherein said bridging agent is selected from the group consisting essentially of: dimethyl sulfoxide; decylmethyl sulfoxide; and tetradecylmethyl sulfoxide; 2-pyrrolidone; N-methyl-2-pyrrolidone; N-(2-hydroxyethyl)pyrrolidone); acetone; dimethyl acetamide; dimethyl formamide; tetrahydrofurfuryl alcohol; and a mixture thereof.

8. The composition according to claim 7 wherein said carrier solvent mixture is selected from the group consisting essentially of: petroleum oil; animal oil; vegetable oil; peanut oil; soybean oil; mineral oil; sesame oil; and a mixture thereof.

9. The composition according to claim 7 wherein said carrier solvent is γ-hexylactone, δ-hexylactone, γ-butyrolactone or a mixture thereof.

10. The composition according to claim 7 wherein said carrier solvent mixture is γ-hexylactone, δ-hexylactone or γ-butyrolactone in combination with one or more solvents selected from the group consisting essentially of: dimethyl sulfoxide; N,N-diethyl-m-toluamide; eucalyptol; dimethyl isosorbide; diisopropyl adipate; and 1-methoxy-2-propyl acetate.

11. The composition according to claim 1 wherein on a weight to volume basis said metaflumizone is present at about 5% to 35%, said bridging agent is present at about 10%; said surfactant is present at about 2% to 8%; and said carrier solvent is present at about 45% to 60%.

12. The composition according to claim 11 wherein said carrier solvent consists essentially of: about 10% N,N-diethyl-m-toluamide; 10% eucalyptol; about 20% 1-methoxy-2-propyl acetate; and about 15% to 45% of γ-hexylactone.

13. The composition according to claim 11 wherein said bridging agent is dimethyl sulfoxide, said surfactant is a non-ionic, low foam surfactant; and said carrier solvent is γ-hexylactone.

14. The composition according to claim 12 wherein said metaflumizone is present on a weight to volume basis of about 25% to 35%.

16. A method for the control of an ectoparasite infestation in a warm-blooded animal which comprises topically administering to said animal an effective amount of a composition according to claim 1.

17. The method according to claim 16 wherein said animal is a dog or a cat.

18. The method according to claim 17 wherein said animal is a dog and said effective amount is about 30 to 120 mg of metaflumizone per kg of body weight.

19. The method according to claim 17 wherein said animal is a cat and said effective amount is about 60 to 240 mg of metaflumizone per kg of body weight.

20. A method for extending the period of efficacy of an ectoparasiticide which comprises topically administering to a warm-blooded animal a high dose of said ectoparasiticide.

21. The method according to claim 20 wherein said high dose is about 2 to 3 times the conventional dose rate for said ectoparasiticide.

22. The method according to claim 21 wherein said period of efficacy is extended for a period of greater than about 6 weeks.

23. The method according to claim 21 wherein said period of efficacy is extended for a period of about 6 to 20 weeks.

24. The method according to claim 21 wherein said ectoparasiticide is metaflumizone, fipronil, imidacloprid, or a mixture thereof.

25. The method according to claim 21 wherein said animal is a dog or a cat.

26. The method according to claim 25 wherein said animal is a dog; said ectoparasiticide is metaflumizone; and said high dose is about 35-120 mg per kg of body weight.

27. The method according to claim 25 wherein said animal is a cat, said ectoparasiticide is metaflumizone; and said high dose is about 60-240 mg per kg of body weight.
